(19) United States
(12) Patent Application Publication
(10) Pub. No.: US 2011/0063101 A1
(43) Pub. Date: Mar. 17, 2011

(54) Carbon Monoxide Safety System And Method

(76) Inventor: Michael Cristoforo, Palm City, FL (US)

(21) Appl. No.: 12/883,312

(22) Filed: Sep. 16, 2010

Related U.S. Application Data
(60) Provisional application No. 61/243,405, filed on Sep. 17, 2009.

(51) Int. Cl. G08B 23/00; G08B 17/10; G05B 15/00

(52) U.S. Cl. 340/501; 340/632; 340/628; 700/275

(57) ABSTRACT

A safety alarm system and method are provided. The alarm system includes a gas detector and a possible fire detector. A controller is provided to process signals from the detectors and provide signals to a vent controller so that if a detected gas level is too high, the vent controller will open a vent. Further, the vent will be prevented from opening if a fire is detected. Alarms may be activated if the detected gas level is too high and if a possible fire is detected. The alarm system can be coupled to a generator set to effect engine shutdown if the detected gas level is too high.

### CROSS REFERENCE TO RELATED APPLICATION

The present application claims the benefit of priority under 35 U.S.C. §119(e) to U.S. Provisional Patent Application No. 61/243,405, filed Sep. 17, 2009, and entitled, “Carbon Monoxide Safety System And Method”, the contents of which are incorporated herein by reference.

### FIELD OF INVENTION

The present invention relates to a carbon monoxide detector system useful in environments that contain devices that burn carbon based fuels such as heaters, furnaces, water heaters and the like. The system includes a gas monitor that is useful to sense the level of toxic gas, such as carbon monoxide (CO) in an enclosure such as a garage or other enclosed area; and if a predetermined level of the gas is sensed by the system, the device can be automatically shut down and a vent device opened to vent the enclosure. The system is also provided with a fire sensor that will selectively prevent automatic opening of the vent device if a potential fire is detected in the enclosed space. An alarm may also be triggered.

### BACKGROUND OF THE INVENTION

Carbon monoxide is an inherent byproduct of combustion of carbon based fuels. It is produced in household fires, fireplaces and appliances such as furnaces, heaters, water heaters, cooking devices and clothes dryers. In high concentrations, CO is toxic to mammals, including humans, when the level of CO reaches or exceeds a certain level. Carbon monoxide can come from the combustion device exhaust. In some areas, such devices are commonly located in garages and basements. One problem that is sometimes tragically encountered is that the exhaust gases from such devices can enter the enclosed space because of a failure to properly vent through a chimney or the like and cause serious harm or even death to humans and animals. Further, against all recommendations, people often operate devices such as cookers in the garage to keep them out of the weather. Cooking, such as smoking, grilling (as with a charcoal grill) and turkey frying are ill advisedly done indoors presenting the same potential hazards as appliances and add a fire hazard as well. Such activities and devices generate harmful gases that can be collected in the garage, basement or crawl space, even when auxiliary vents, such as doors and windows are open.

Detectors are available to sense some of these gases and provide an alarm. Smoke detectors are also available to indirectly indicate that a fire might be occurring. Their function is to provide an audible alarm, and some provide a light to assist in egress from the site by people. There at one time was an alarm system that opened the garage door when excess CO was detected in the garage to vent the garage. However, in one alleged case, venting caused a back draft because a fire was present resulting in death of occupants and fire fighters.

There is thus a need for an improved gas detection alarm system and a method of its operation.

### SUMMARY

The present invention involves the provision of an alarm system that includes detectors and a vent controller. The detectors include a first detector operable to sense the level of at least one gaseous component of carbon fuel combustion to indicate the concentration of at least one of carbon monoxide and carbon dioxide in an enclosed space and provide a first signal indicative of an excess concentration of at least one of carbon monoxide and carbon dioxide. The detectors also include a second detector operable to sense the possible presence of fire in the enclosed space and operable to provide a second signal indicative of the possible presence of fire. A controller is operably coupled to the first and second detectors and is operable to provide a signal to a vent controller to effect opening of a vent when the concentration of at least one of carbon monoxide and carbon dioxide exceeds a predetermined level and if the second detector does not sense a possible presence of fire. The controller is operable to provide an alarm signal when the first detector provides the first signal and to provide an alarm signal when the second detector provides the second signal. The alarm signals may be different to indicate the type of problem sensed.

The present invention also involves the provision of a method of operating a vent system for an enclosed space. The method includes operating a first detector in proximity to an enclosed space adapted to house one or more mammals. The first detector is operable to detect the presence of at least one gaseous component of carbon fuel combustion to indicate the concentration of at least one of carbon monoxide and carbon dioxide in an enclosed space and provide a first signal indicative of an excess concentration of at least one of carbon monoxide and carbon dioxide. A second detector is operated in proximity to the enclosed space and is operable to detect the possible presence of fire in the enclosed space and provide a second signal indicative of the possible presence of fire in the enclosed space. The first and second signals are monitored for a potential problem. A third signal is generated if the first signal indicates excess concentration of at least one of carbon monoxide and carbon dioxide and the second detector indicates absence of fire; then the third signal is used to effect opening of a vent to the enclosed space. A fourth signal is generated if excess concentration of at least one of carbon monoxide and carbon dioxide is detected by the first detector and is used to activate an alarm. A fifth signal is generated if a possible fire is detected by the second detector and is used to activate an alarm.

### BRIEF DESCRIPTION OF THE DRAWINGS

FIG. 1 is a schematic illustration of a carbon monoxide safety system usable adjacent an enclosed space habitable by one or more mammals.

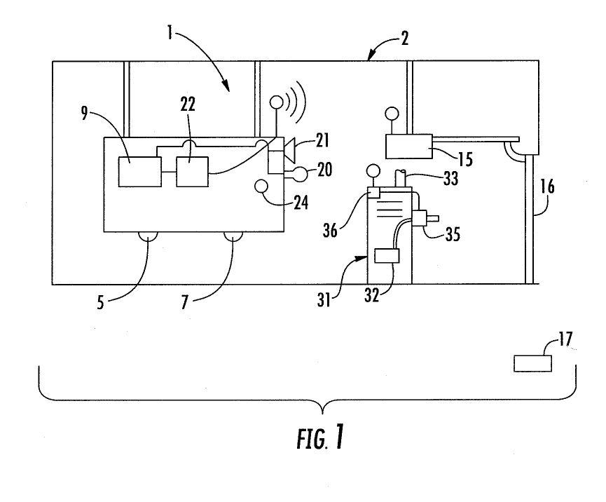

Like numbers used throughout this application represent like or similar parts and/or construction.

### DETAILED DESCRIPTION OF THE INVENTION

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

The reference numeral 1 designates generally an alarm system operable to detect an excess level of a gas indicative of there being combustion of a carbon based fuel venting to an enclosed space 2, such as carbon monoxide and/or carbon dioxide. The system 1 is also operable to detect the possible presence of a fire in the space 2. The system 1 is operable to either sound an alarm if the detected gas is above a predetermined level or if there is a possible fire. The system 1 is also operable to effect venting of the enclosed space if the detected gas level is too high and there is no detected possible fire.

The system 1 includes a plurality of detectors with one detector 5 being operable to detect a gaseous component in the atmosphere of the space 2 indicative of the concentration of a gaseous component of combustion of a carbon based fuel such as at least one of carbon monoxide and carbon dioxide. Another detector 7 is operable to sense the possible presence of a fire in the space 2 such as by the use of a temperature or smoke detector. A controller 9 is provided and is coupled to the detectors 5, 7 and is operable to provide at least one signal to control operation of other components of the system 1 such as selected venting of the space 2 and/or sounding an alarm as discussed below. The controller 9 can include a PLC (programmable logic controller).

The detector 5 is operable to sense the level of at least one gaseous component of carbon fuel combustion to indicate the concentration of at least one of carbon monoxide and carbon dioxide in the enclosed space 2 and provide a signal indicative of an excess concentration of the gaseous component. It is preferable to sense carbon monoxide directly, although it is to be understood that the level of carbon monoxide could be sensed indirectly. The detector 5 is operable to provide a signal when a predetermined level of carbon monoxide is met or exceeded. The signal is provided to the controller 9 and processed as described below. Carbon monoxide level detectors are well known in the art.

The detector 7 is operable to sense the possible presence of fire in the enclosed space 2 and to provide a signal indicative of the possible presence of fire. This can be done with a static or movable infrared detector sensing for temperature above a predetermined minimum. Temperature above a certain predetermined minimum value is an indirect indication of a possible fire. The detector 7 could also detect smoke. The detector 7 provides a signal to the controller 9 to indicate a possible fire and is processed as described below. Temperature sensors and smoke detectors are well known in the art. The detector 7 may be as simple as a thermocouple to detect air temperature or could be an infrared sensor that is operable to view an area either in a static condition or could sweep an area looking for a hot spot in the space 2. A combination of fire detector types could also be used.

The controller 9 is operably coupled to the detectors 5, 7 and is operable to provide a signal to a vent controller/actuator 15 to effect opening of a vent 16 when the concentration of at least one of carbon monoxide and carbon dioxide exceeds a predetermined level as indicated by the detector 5 and if the detector 7 does not sense a possible presence of fire. If there is a possible fire, the vent 16 will be prevented from opening in order to prevent a possible back draft and supplying additional oxygen to the fire. However, an alarm will be activated indicating the presence of a fire. In the case of a garage as the space 2, the vent 16 can be the main overhead door and the vent controller 15 can be an electrically operated door opener as is known in the art. In other areas such as a basement or crawl space, a dedicated vent and an exhaust fan can be provided. The controller 9 is also operable to provide an alarm signal when the detector 5 provides a signal indicating carbon monoxide above a predetermined level. The controller provides an alarm signal and prevents the dedicated vent or exhaust fan from operating when the detector 7 provides a signal indicating a possible fire. The alarm can be visual and/or audible. A suitable visual alarm 20 can be a flashing light and a suitable audible alarm 21 can be a suitable sound from a speaker connected to a sound generator. The controllers 9, 15 can be operably coupled wirelessly using RF transmission and/or by wire. The alarms 20, 21 may be positioned in the space 2 or in another space, such as a house, and can be operably coupled to the system controller 9 wirelessly and/or by wire.

The controller 9 is operably coupled to a signal generator 22 that is operable to provide a control signal to the vent controller 15. Preferably the signal generator 22 includes a wireless radio transmitter and the vent controller 15 includes a wireless radio receiver to effect communication.

The controller 9 or the signal generator 22 is operable to be encoded with an operating rolling code for the vent controller 15, such as a wirelessly controlled overhead door opener, so that both a wireless remote controller 17, such as those carried in a car, and controller 9 can be used while protecting the security code for the remote controller. Either controller 9 or 17, can be used to open the door 16. Setting the rolling code in the controller 9/signal generator 22 can be done, as is known in the art, as by depressing a set button 24. Such rolling code setting in a second transmitter contained in the wireless remote controller 17 is well known in the art. In the event of a fire the wireless remote controller 17 carried in the car would also be prevented from opening the garage door 16.

The reference numeral 31 designates generally an appliance such as a furnace, dryer, space heater, water heater, cooking device or the like that uses a carbon based fuel as an energy source. The system 1 is operably coupled to the device 31 either wirelessly or by so-called hard wiring to effect shut down of the device upon receipt of a signal from the signal generator 22 if one or more exhaust gas components reach a predetermined level or concentration in the space 2 or a possible fire is detected. A device 31 has some form of fuel combustion device 32, e.g., a burner. A typical fuel could be natural gas, propane, heating oil or the like. A vent 33 can be provided to normally exhaust combustion products. The detector 5 and system controller 9 can be used to terminate operation of the device 31 if the detector 5 senses a predetermined amount of carbon monoxide in the air in the space 2 as described above or if a possible fire is detected by the detector 7. Shut down can be accomplished by terminating flow of fuel to the device 31 as by closing a fuel valve 35. The device 31 can be provided with a receiver 36 operable to receive a shut down signal from the controller 9 and/or signal generator 22 when the level of carbon monoxide is indicated as having reached a predetermined maximum. The received signal initiates a shut down procedure of the device 31 as by shutting off of fuel by closing an electrically operated valve 35.

The space 2 may be any suitable space that can be occupied by one or more mammals such as people, pets and livestock. Generator sets are often operated in proximity to such spaces. The space 2 may be part of a house, apartment, townhouse, RV, camper, tent, barn, garage and the like.

The present invention is better understood by a description of its operation. A fuel consuming device 31 is in proximity to an enclosed space 2, as by being positioned in the space 2. The space 2 is adapted to house one or more mammals or is connected to a space adapted to house one or more mammals. The space 2 may be part of a house, shed, garage, barn, tent, RV or the like. During operation, the device 31 produces exhaust gas. The space 2 is monitored for air quality for the presence and concentration of a toxic gas from the device 31 or other sources which are produced by combusting a carbon based fuel source such as wood, paper, fabric, plastics, elastomers and the like. The toxic gas, e.g., CO, concentration may be monitored directly by the detector 5 or indirectly using another sensed compound that is indicative of the level of the toxic gas. A signal is generated by signal generator 22 when the concentration of the toxic gas is indicated as being above a predetermined level. One or more signals are transmitted to the alarms 20, 21 and to the receiver 36 to effect alarm activation and device shutdown. If there is no possible fire indicated by the detector 7, the controller 15 will also receive a signal to open the door and vent the space 2. If a possible fire is detected, controller 15 is not activated keeping the door 16 closed.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An alarm system comprising:
a first detector operable to sense a level of at least one gaseous component of carbon fuel combustion which indicates the concentration of at least one of carbon monoxide and carbon dioxide in an enclosed space and provide a first signal indicative of an excess concentration of the at least one of carbon monoxide and carbon dioxide; and
a controller operably coupled to said first detector and operable to provide a first signal to a vent controller to effect opening of a vent when the concentration of at least one of carbon monoxide and carbon dioxide exceeds a predetermined level, said controller being operable to provide an alarm signal when said first detector provides the first signal.

2. The alarm system of claim 1 including a second detector operable to sense the presence of a fire in said enclosed space, said second detector operable to provide a second signal indicative of the presence of a fire, said controller operably coupled to said second detector and operable to provide a second signal to said vent controller to effect opening of said vent when the concentration of at least one of carbon monoxide and carbon dioxide exceeds a predetermined level and when the second detector does not sense a presence of a fire, said controller being operable to provide said alarm signal when said first detector provides said first signal and when said second detector provides said second signal.

3. The alarm system of claim 1 wherein said enclosed space is a garage and said vent is a garage door.

4. The alarm system of claim 2 wherein said enclosed space is a garage, said vent is a garage door, said controller operably coupled to said second detector and operable to provide a third signal to said vent controller to prevent opening of said vent when the concentration of at least one of carbon monoxide and carbon dioxide exceeds a predetermined level and when the second detector detects the presence of a fire.

5. The alarm controller of claim 4 wherein said third signal is sent to a wireless remote garage door opener which has been associated with said garage door, said third signal preventing the opening of said garage door by said remote garage door opener when the presence of a fire has been detected.

6. The alarm system of claim 4 wherein said controller is encoded with an operating rolling code which operates in conjunction with a garage door opener to open said garage door only by authorized individuals.

7. The alarm system of claim 2 including an appliance in said enclosed space, said appliance including a fuel cutoff, said fuel cutoff is operated to stop the supply of fuel to appliance in response to said first signal.

8. A method of operating a vent system for an enclosed space, the method comprising:
operating a first detector in proximity to an enclosed space, said first detector detecting the presence of at least one gaseous component of carbon fuel combustion which indicates a concentration of at least one of carbon monoxide and carbon dioxide in an enclosed space, said first detector providing a first signal indicative of an excess concentration of the at least one of carbon monoxide and carbon dioxide; and
operating a controller, said controller being operable in response to said first signal to open a vent in said enclosed space, said vent allowing the release of said concentration of said at least one of carbon monoxide and carbon dioxide from said enclosed space.

9. The method of claim 8 including operating a second detector in proximity to said enclosed space, said second detector detecting the presence of a fire in said enclosed space, said second detector providing a second signal, said second signal indicating the presence of a fire in said enclosed space.

10. The method of claim 9 including monitoring said first and said second signals;
generating a third signal when said first signal indicates said excess concentration of at least one of said carbon monoxide and said carbon dioxide and said second detector indicates the absence of a fire; and
operating said controller to open said vent in response to said third signal.

11. The method of claim 10 including generating a fourth signal when said first signal indicates said excess concentration of at least one of said carbon monoxide and said carbon dioxide, said fourth signal activating an alarm.

12. The method of claim 11 including generating a fifth signal when said second detector detects the presence of a fire in said enclosed space, said fifth signal activating an alarm.

13. The method of claim 10 wherein said enclosed space is a garage, said vent is a garage door, operating said controller to prevent opening of said garage door in response to said third signal and said second detector detecting the presence of a fire.

14. The method of claim 10 wherein said enclosed space is a garage, said vent is a garage door, operating said controller to prevent opening of said garage door by a wireless remote control in response to said third signal and said second detector detecting the presence of a fire.

16. The method of claim 14 including providing said controller with a rolling code which operates in conjunction with a garage door opener to open said garage door only by authorized individuals.

17. The method of claim 8 including an appliance in said enclosed space, said appliance including a fuel cutoff, said fuel cutoff being operated to stop the supply of fuel to appliance in response to said first signal.
